(19) United States
(12) Patent Application Publication
(10) Pub. No.: US 2018/0161701 A1
(43) Pub. Date: Jun. 14, 2018

(54) MULTI-STAGE SEPARATION DEVICE FOR USE WITH FLOWABLE SYSTEM OF SUBSTANCES

(71) Applicant: Tomle Strategies Pty Ltd, Northbridge NSW (AU)

(72) Inventors: Leo Crasti, Penrice SA (AU); David Tomlinson, Northbridge NSW (AU)

(21) Appl. No.: 15/738,948

(22) PCT Filed: Jun. 23, 2016
(86) PCT No.: PCT/AU2016/000227

§ 371 Date: Dec. 21, 2017

(30) Foreign Application Priority Data
Jun. 25, 2015 (AU) 2015902459
Mar. 22, 2016 (AU) 2016901066

(51) Int. Cl. B01D 21/26; B01D 15/18; B01D 21/24

(52) U.S. Cl. CPC B01D 21/26; B01D 17/0217; B01D 21/24; B01D 15/18

(57) ABSTRACT

A multi-stage separation device for separating a first fluid from at least one other second substance, the first fluid and second substance forming a flowable system of substances. The device comprising a housing having a substantially cylindrical form about a central axis with a wall disposed between a first end and second end, and an inlet disposed near said first end of the housing and an outlet in the second end. The wall when viewed in cross section perpendicular to the central axis has an ever decreasing radius spiraling between at least a first edge of said wall and a second edge of the wall. The first edge and second edge form part of the periphery of an inlet in the housing. At least one permeable cylindrical separation module is disposed within the housing.

### TECHNICAL FIELD

The present invention relates to a multi-stage separation device for separating a first fluid from at least one other second substance. In particular, the invention is described with reference to embodiments for use in aquaculture, other water treatment applications and various and applications including other liquids, gases and volatiles.

### BACKGROUND

There are many known separation devices for separating at least one contaminant substance from a fluid. Examples of just some separation devices include oil filters, water filters, biological waste water treatment systems, ammonia removal by ion exchange, scrubber systems for removing particulates and/or gases from industrial exhaust streams, natural gas dehydration using absorption by liquid desiccants and adsorption by solid desiccants. In most instances such separation devices are purpose built to suit only one application and environment. For example the housing/container and internal filter media of a certain filter is purpose built for a particular application, and typically can be used for only a single mode of separation.

One well known separation device is a hydrocyclone which separates particles in liquid suspension or liquids of different densities based on the ratio of their centripetal force to fluid resistance. This ratio is high for dense (where separation by density is required) and coarse (where separation by size is required) particles, and low for light and fine particle. A hydrocyclone will typically have a cylindrical section at the top where liquid is being fed tangentially, and a conical base. The angle, and hence length of the conical section, plays a role in determining operating characteristics. A conventional hydrocyclone typically has two exits, one on the bottom (underflow), and one at the top (overflow). Most simple hydrocyclones perform a single stage separation step, in which forces associated with a vortex created within the chamber, urge denser particles towards the periphery of the chamber. As a result, the liquid near the centre of the vortex has a lower concentration of denser particles than at the periphery. Separation efficiency may be improved by including a filter within the centre, such that a portion of the liquid passes through the filter. This is known as combining cyclonic separation with cross-flow filtration, and examples of such embodiments are referred to in various prior art documents listed in the background of WO/2013173115 (Dow Global Technologies LLC). As acknowledged in this prior art, where cross filtration is used in a hydrocyclone, the feed velocities required to generate a vortex can result in accelerated wear and fouling of the filtration membrane. It is quite common for such filtration membranes to become clogged. Many attempts to overcome the positioning of a filtration membrane inside a hydrocyclone actually impact on the efficiency of the vortex operation. For example, in WO/2013173115 the use of paddles for wiping the filtration screen will not work effectively, firstly because wiping the filter screen can further clog the filter, and secondly they may impact on the establishment of the necessary vortex for the device to operate. In prior art U.S. Pat. No. 7,632,416 (Levitt) a hydrocyclone is depicted with various filtration assemblies, including a stepped filtration assembly. As admitted in U.S. Pat. No. 7,632,416, there is a tendency for the filtration assemblies to clog up, and a cleaning structure (brush assembly) as depicted in FIG. 11 of this prior art is placed in the chamber to continually spin around the chamber and to continually clean the filter. This cleaning structure utilises rollers acting on the chamber wall, which in use will jam or get stuck within the conical chamber. The cleaning structure has the intent of preventing clogging of the filtration assembly, but it now places a structure capable of jamming and/or interfering with the generation of a vortex within the hydrocyclone, thus raising other operational disadvantages.

There are at least two disadvantages associated with prior art hydrocyclones. Firstly, conventional hydrocyclones are suited to a single step separation process, and therefore are not suited for use in multi-stage separation in the single device. Secondly, when you place a cross filtration assembly therein, any attempt to prevent clogging of the filtration assembly in use, will significantly decrease the vortex efficiency of the hydrocyclone device.

In some instances, there are environments where there are a multitude of separation devices and systems, to provide various modes of separation required for that environment. Such environments would benefit from separation devices having multi-stage capability to minimise the disparity of devices employed. There are also environments where very little separation/segregation/filtration processes are used, but would benefit from using a multi-stage separation device.

Aquaculture (farming) of the Australian freshwater fish known as the Murray Cod, has been known for over thirty years, and in more recent times has become more lucrative as its desirability as a table fish has increased. The farming of this fish, like many others occurs in various stages from hatchlings out of eggs, grow-out and preparation for delivery to market. Generally, many producers accept losses of thirty percent from hatchery to weaning of fingerlings due to “ammonium spike” in the water. Typical losses from grow-out stage to harvesting, is about five to ten percent. Other than aeration to water, most producers do not place much effort in treating the water quality. Improving the quality of the water environment would reduce losses of stock at the various stages, and would improve growth rates and size, as well as the overall edible quality of the fish. To treat and improve the water environment using prior art devices (and processes), requires a number of separation (treatment/segregation) devices and/or systems. Treatment of the water influent, particularly in the grow-out to harvesting stages requires removal of gross debris, nitrogen in the form of breakdown products of life eg tertiary amines & ammonium ion, non colloidal particulates, fish eggs (particularly those of European carp), fungal mycelia & spores, and protozoan parasites. Typically the tanks/ponds in which the Murray Cod are processed are aerated, and as the fish are excreting nitrogen as urea and ammonium ion, build up of these materials and the oxidation of same will affect the health of the fish.

In the “grow-out” ponds it is optimally preferred that the water is muddy (a colloidal suspension) to provide an environment similar to the natural environment of the Murray Cod. In grow-out, it is important to reduce the nitrogen in the pond, and keep the level low. If the aeration system in the “grow-out” ponds is functioning well, the reduced nitrogen (ammonium ion) is effectively oxidised to nitrite and nitrate ions. They too at raised levels are injurious to fish and other aquatic life forms. They reduce immunity, so weakening the fish and making them more susceptible to infection from pathogenic organisms.

After harvesting and before transport to market, fish are placed in a large “purging” tank filled with clear water and held without food for hours or a small number of days to clean out their GI tracts and to reduce the muddy taste. In effect this placement of the fish in clear water, is attempting to remove “muddy” colloidal material from the fish in a simplistic manner before they are transported to market.

A preferred treatment solution to reduce and keep the total nitrogen level low is to remove the ammonium ion using a zeolite absorption filter in both the in-grow pond and purging tank. However, in the grow-out pond it is not desirous to remove the muddy (colloidal mixture), but rather treat the influent with zeolite absorption to reduce nitrogen along with other filtration devices/processes to deal with fish eggs, fungal spores, parasites and the like. As such whilst the “muddy” colloidal mixture is not to be removed from the water in the in-grow pond, it must be handled in a way that it does not impede on the filtration required to deal with the contaminants which must be removed from the water environment. In this case the muddy colloidal particles would have be first screened (or blocked) by a screening material filter allowing it to return to the pond. Water would then continue onto the other filtration devices eg to reduce nitrogen in the form of positively charged ammonium ions, protozoan parasites, snails and the like. However, in the purging stage any filtration devices would preferably be required to remove the muddy colloid particles and to reduce nitrogen in the form of positively charged ammonium ions using zeolite absorption. The amount of zeolite treatment in the purging tank stage will be considerably less than what is required in the grow-out pond stage.

It is possible to employ known prior art solutions to deal with each stage separately, requiring different devices/systems for each stage. However it would be desirable to employ a single multi-stage separation device that could be used in both the grow-out stage pond and the purging stage tank. Preferably, the separation device would also be multi-modal so that a single separation device could deal with more than one type of separation/treatment process. This would make the use of such device more economically viable and easier to use by those farming the Murray Cod, as well as those farming other aquatic species.

There are known filter cartridges that are typically used to filter out particulate material from a fluid (liquid or gas). The primary method of operation employed by conventional filters is to intercept the flow with either a screen or filter media, which has a smaller aperture than the smallest particles which are intended to be removed. This is commonly known as an “attack filter” or screening process. As particles are captured, the available apertures reduce in number hence causing a reduction in filtering performance until the screening or filter media becomes totally blocked and filtering stops. The system removal capacity is directly related to the volume of material that the screen of filter media can hold. Of further significance, is that fluid flow velocity through a screen or filter media increases as the available apertures reduce. This has a compounding effect of increasing the differential pressure across the screen or filter media interface. This increase in differential pressure often accelerates the degradation of screening performance and service life. As such any attempt to multi-stage a separation device, ie provide a filtration device with multiple stages of filtration must address this issue, as the deterioration of performance of the first stage of filtration, namely a blocked screen, will impact on the next or second (downstream) stage of filtration, say a some filtration media. This is one of the reasons that performance may be an issue using conventional technology to attempt to say remove colloidal particles (eg from muddy water) and treat the same water using zeolite adsorption (to remove nitrogen in the form of positively charged ammonium ions) in a single separation (filtration) device. This is because you have to ensure that the zeolite treatment in the second filtration stage is not unduly impacted upon by blocking and therefore degradation of the screen/media used to remove the muddy colloidal particles.

A multi-stage separation device would also have a plurality of other applications, including the treatment of other water applications, such as in recycling of grey water, irrigation water, and for environmental flows, as well as the treatment of other fluids (liquids and gases) in commercial and industrial processes.

It is desirable to provide a multi-stage separation device, which is capable of removing and/or transforming a broad spectrum of impurities/contaminants from a fluid in a variety of orientations. It also should have the ability to vary the separation performance by applying different membranes or media.

The present invention seeks to ameliorate at least one of the disadvantages of the prior art.

### SUMMARY OF INVENTION

In a first aspect, the present invention consists of a multi-stage separation device for separating a first fluid from at least one other second substance, said first fluid and said second substance forming a flowable system of substances, said device comprising:

a housing having a substantially cylindrical form about a central axis with a wall disposed between a first end and second end, an inlet disposed near said first end of said housing and an outlet in said second end, wherein said wall when viewed in cross section perpendicular to said central axis having an ever decreasing radius spiraling between at least a first edge of said wall and a second edge of said wall, said first edge and second edge form part of the periphery of an inlet in said housing, and at least one permeable cylindrical separation module disposed within said housing.

Preferably said inlet allowing said flowable system of substances to enter said housing such that flow thereof passes through said separation module as it flows towards said outlet, and at least a portion of said second substance is separated from said first fluid as it passes through said module.

Preferably said flowable system of substances entering said inlet at least initially has a spirally inward path imparted thereto.

Preferably said at least one module provides multi-modal separation.

Preferably said at least one module is a plurality of modules nested together.

Preferably at least two of said plurality of modules provide dissimilar modes of separation to each other.

Preferably said at least one module is made up of at least two segments, each segment providing a mode of separation dissimilar to each other.

Preferably said device is housed in a chamber.

Preferably said chamber houses a plurality of like said multi-stage separation devices.

Preferably said device can be used with anyone one more flowable system of substances, including solids in liquid, sols, soluble solids, solids in gases, liquids in liquids and liquids in gases.

In one embodiment said module is disposable.

Preferably in one embodiment said module is rotatable about said central axis. The rotation of said module is driven by the flow of the flowable system passing through said device, or alternatively the rotation of said module is driven by an external drive source.

Preferably in another embodiment said flowable system of substances entering said device is pressurised. Preferably said flowable system of substances is pressurised by a pump disposed upstream of said device.

Preferably said separation module includes any one or more of separation media, filtration media, catalytic material, hydrophobic material, hydrophilic material, oxidant material, reductant material, metal or microbes.

Preferably in one embodiment said separation module comprises a material that transforms said second substance.

Preferably in one embodiment said separation device is integral with a buoy.

Preferably in one application said separation device is used in aquaculture to treat contaminated water.

Preferably in another application said separation device is used to treat environmental water flow.

Preferably in a further application said separation device is used to treat malodourous and/or volatile gases.

Preferably in an even further application said separation device is used to heat or cool air.

### BRIEF DESCRIPTION OF DRAWINGS

FIG. 1 is a perspective view of a multi-stage separation device in accordance with a first embodiment.

FIG. 2 is an enlarged cross-sectional view of the multi-stage separation device of FIG. 1 in a plane perpendicular to axis L (and passing through the housing and module), with arrows depicting the nature of flow therethrough.

FIG. 3 is a schematic elevational view of the multi-stage separation device of FIG. 1, with a sump fitted.

FIGS. 4a and 4b depict a module, individually and nested together respectively, that are removably fitted within housing of multi-stage separation device of FIG. 1.

FIG. 5 is a perspective view of a multi-stage separation device of FIG. 1 with suction imparted to the flow.

FIG. 6 is a perspective view of a multi-stage separation device of FIG. 1 inside a first type of chamber.

FIG. 7 is a perspective view of a multi-stage separation device of FIG. 1 used in buoy arrangement.

FIG. 8 is a perspective view of a multi-stage separation device of FIG. 1 inside a second type of chamber, suited for treatment of environmental water flow.

FIG. 9 is a perspective view of a plurality multi-stage separation devices as shown in FIG. 1, inside a third type of chamber, suited for treatment of environmental water flow.

FIG. 10 depicts an exploded perspective view of an impeller/drive mechanism for rotating the module of multi-stage separation device of FIG. 1.

FIG. 11a depicts a cross sectional view of the module of multi-stage separation device of FIG. 1 being rotated.

FIG. 11b depicts an enlarged “quadrant” portion of the rotating module and the velocity detail.

### DESCRIPTION OF PREFERRED EMBODIMENTS

In this specification a “flowable system of substances” (FSS) means a system of substances where at least one of the substances is a fluid, allowing the system to flow. The system may be a mixture, solution, dispersion, sol, emulsion, liquid or solid aerosol, or foam.

In this specification “multi-stage separation” with reference to a separation device, means that more than one separation step or process occurs within the separation device.

In this specification a “mode of separation” relates to a type of separation that may include but is not limited to screening, entrapment, partitioning, adsorption, absorption, magnetic attraction, chemical attraction, electrical attraction, electrostatic coagulation and hydrophobic interaction, hydrophilic interaction, microbial treatment, or a form of transformation such as phase transition.

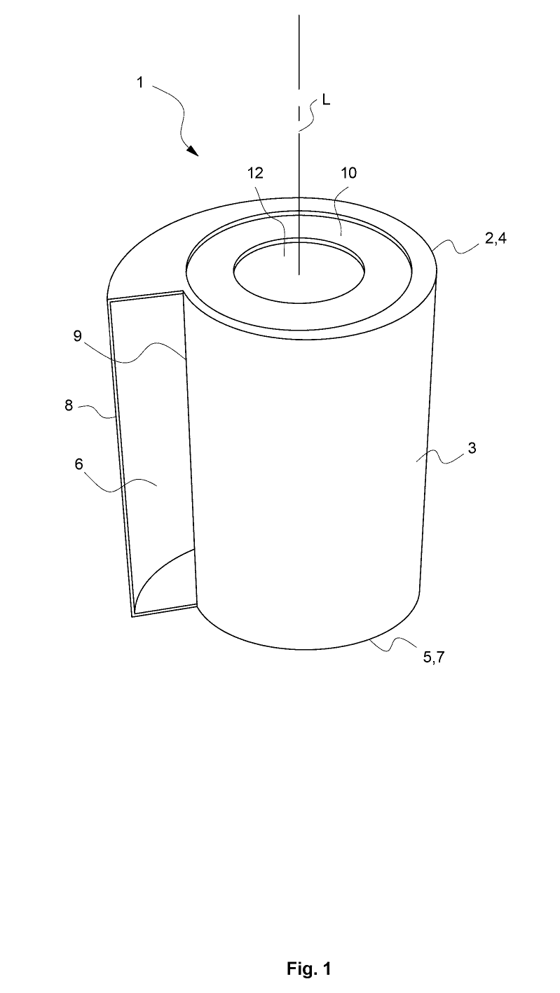

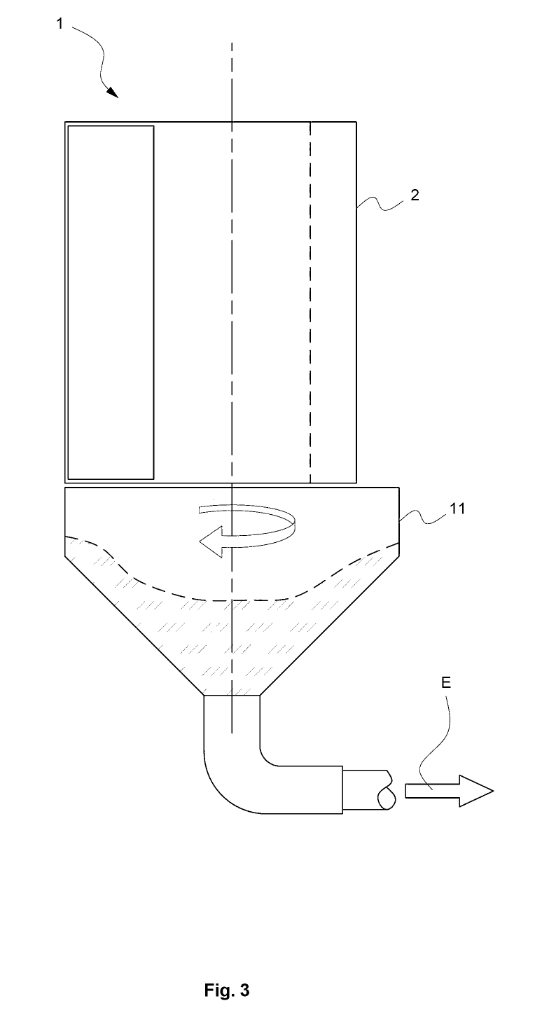

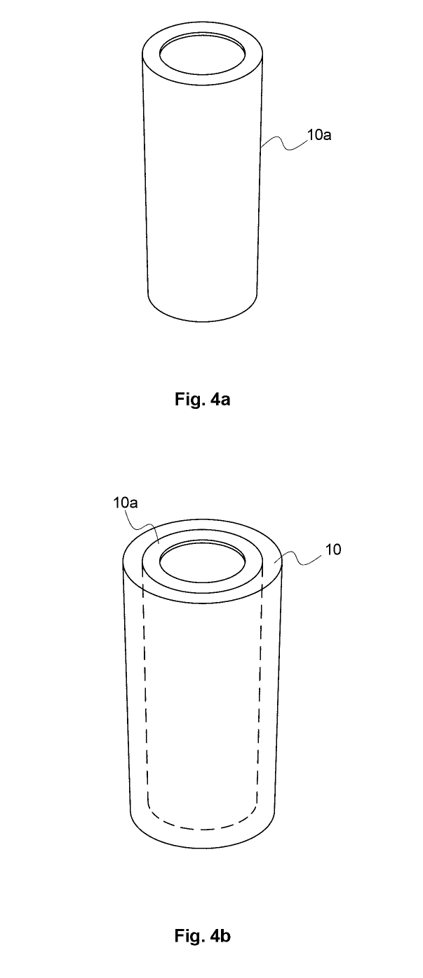

FIGS. 1 to 4 show a first preferred embodiment of a multi-stage separation device 1 for separating a first fluid from at least one other substance from a flowable system of substances (FSS).

Multi-stage separation device 1 comprises a housing 2 having a substantially cylindrical form about a central axis L with a wall 3 disposed between a first end (top) 4 and second end (bottom) 5. Housing 1 has an inlet 6 and an outlet 7. Housing 1 is attached to a sump 11, which in this embodiment is conically shaped.

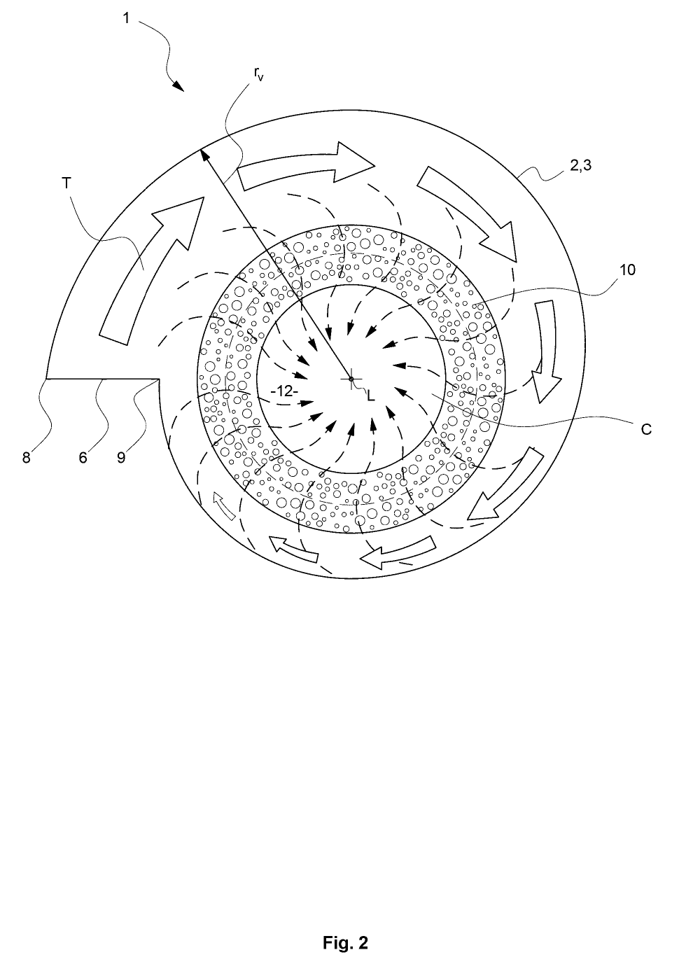

Wall 3, when viewed in cross section as seen in FIG. 2, has an ever decreasing radius rᵥ spiraling between a first edge 8 thereof, and a second edge 9. Edges 8, 9 form part of the periphery of inlet 6 in housing 2.

A permeable cylindrical separation module 10 is removably disposed within housing 2.

Module 10 may preferably be made of a single media of separation material, or a plurality of separation materials. Where module 1 is made plurality of separation materials, these materials, could be in individual concentric layers or interspersed with each other in one or more layers. Module 10 has a core 12, which could be hollow or solid.

In use, with housing 2 fitted to sump 11, and with a separation module 10 disposed within housing 1, the FSS enters the device 1 via inlet 6.

The FSS may require particulate removal and some other second filtration treatment. For example, the FSS may be water used in aquaculture requiring a mud/clay particulate (clay particles) to be removed and the water further treated for the removal of ammonium ions by zeolite absorption. In such an example module 10 would be made of or contain zeolite, and be made with a porosity suited to allow the water containing the ammonium ions to pass through, but not the clay particles to be removed. Module 10 may have an external screen material of dissimilar material to the zeolite acting to screen out the particulate material.

As the FSS enters inlet 6 of housing its flow, depicted by arrows T, is directed at a tangent to the surface of module 1, ie namely to the screen and filtration media. This imparts a self-cleaning action whereby the clay (or other) particles are deflected by the surface of module 10. As the surface of module 10 is substantially cylindrical (circular in cross-section) a centrifugal force is imparted to the clay particles forcing them outwardly and minimising their contact with module 10. The surface velocity of flow is maintained substantially constant by the ever-decreasing radius rᵥ (similar to Archimedean spiral) of wall 3 to maintain a constant tangential flow compensating for the internal flow towards the centre through module 11, depicted by arrows C.

As the flow C is directed through module 10, the now treated water falls through its core 12 towards sump 11 in a circular motion and then the treated flow exits, see arrow E. Clay particles have fallen externally of module 10 into sump 11. Housing 2 may have internally disposed vanes (not shown) which may further assist directing clay particles into sump 11.

As sump 11 is preferably partly conically-shaped it can be part of a captured particle removal system. Alternatively or additionally, housing 1 and module 10 could be removed from sump 11, for manual or mechanised eduction (removal) of the collected clay particles. The abovementioned example has been described with reference to simple multi stage separation of aquaculture water, requiring the removal of clay particulate material (a first stage separation step) and the removal of ammonium ions using zeolite in module 10 (a second stage separation step). However, what should be understood is that separation device 1, can be used for various aquaculture applications as well as others including other water recycling and environmental treatment purposes, or in many other applications where the fluid of an FSS requires treatment/purification etc.

Module 10 of separation device 1 can be varied to suit the specification of the FSS “influent to effluent” requirements, by varying the screen type, size and media type used to make the module 10. Furthermore module 10 could be nested with one or more like modules 10a of different filtration media, and core 12 could either be hollow or itself a particular filtration media type.

Regardless of what module arrangement is used, the screen interface relationship of tangential velocity and differential pressure remains is preferably held substantially constant within separation device 1. This is as a result of the variable volumetric relationship between the overall flow and the through flow internal to the media material used for module 10, and may be adjusted by monitoring the permeability of the media used for module 10 (and any additional modules 10a nested with it).

Media permeability can also be regulated to vary residence time of the flow within separation device 1, allowing the selected media to be used in module 10 (and any other nested modules) to exhibit optimal performance/efficiency characteristics. Regulation of media permeability can also be used to target the reduction of constituents (substances) to be removed from the fluid being treated.

In module 10 (and any other nested modules 10a) the media can be introduced as either loose or suitably restrained, or as “cores” or “rings” which have been preformed. By rings we mean annular or doughnut-shaped filter segments, stacked on top of each other to form modules 10 or nested modules 10a. These cores or rings can be of a homogenous media type or may be a blend designed to suit the particular requirements of the FSS being treated. Some media may preferably be reusable by back-flushing or other regeneration techniques, or may disposed or recycled subject to toxicity and biological factors. Furthermore, when stacked rings are used, each ring may have mixed media or there may be different media in the rings being stacked.

In the abovementioned first embodiment, the substantially cylindrical surface of module 10 imparts a centrifugal force to the clay particles in the FSS forcing them outwardly and minimising their contact with module 10. If the module 10 (and optionally 10a) is operably rotated about central axis L during operation of device 1, then it may increase the centrifugal forces imparted on the FSS, thereby making device 1 more efficient. This rotation of module 10, may be driven utilising an externally power source (not shown), or by an impeller attached thereto able to be rotated by the flow of the FSS. Such rotation of module 10 will be dependent on the nature and components of the FSS. In order to improve screening efficiency, module 10 (screen insert) tis rotated in the direction of the fluid flow.

It should be noted that an important feature of the present embodiment of the invention is the ever-decreasing radius rᵥ (similar to an Archimedean spiral) of wall 3 of housing 2. This feature is not found in the prior art separation devices such as hydrocyclones. In this specification “ever decreasing radius” of the wall, is the radius shown when the housing (or chamber) and module is viewed in a planar cross-section perpendicular to the central (longitudinal) of the housing 2 and module 10 of device 1. When you look at FIG. 2, which is a “planar” cross section perpendicular to central (longitudinal) axis L, you will see that radius rᵥ is significantly larger near the inlet side than it is on the opposed side. This is because of the spiral form of wall 3. In a prior art housing having a conventional cylindrical or conical chamber, the result of fluid flow is a slowing down of the fluid velocity at the module/screen interface, which leads to increase in differential pressure, which in turn would cause clogging/blocking of the module/screen. However, the ever decreasing radius rᵥ of wall 3 in the present embodiment as seen in FIG. 2, assists in maintaining a constant fluid velocity, which in turn assists in maintaining a constant low differential pressure, and thus localised pressurised zones in the module/screen are minimised or avoided.

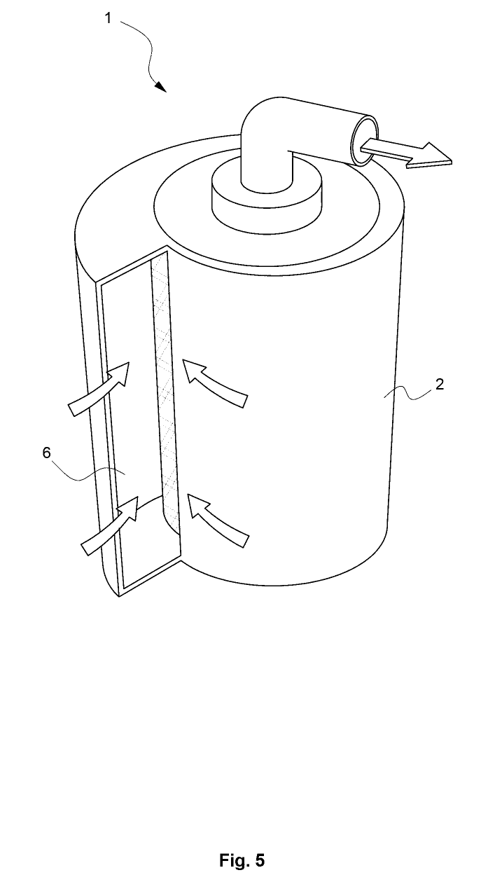

Some applications of multi-stage separation device 1 will now be described with reference to FIGS. 5 to 8.

FIG. 5 shows separation device 1 where the flow is imparted there through by suction.

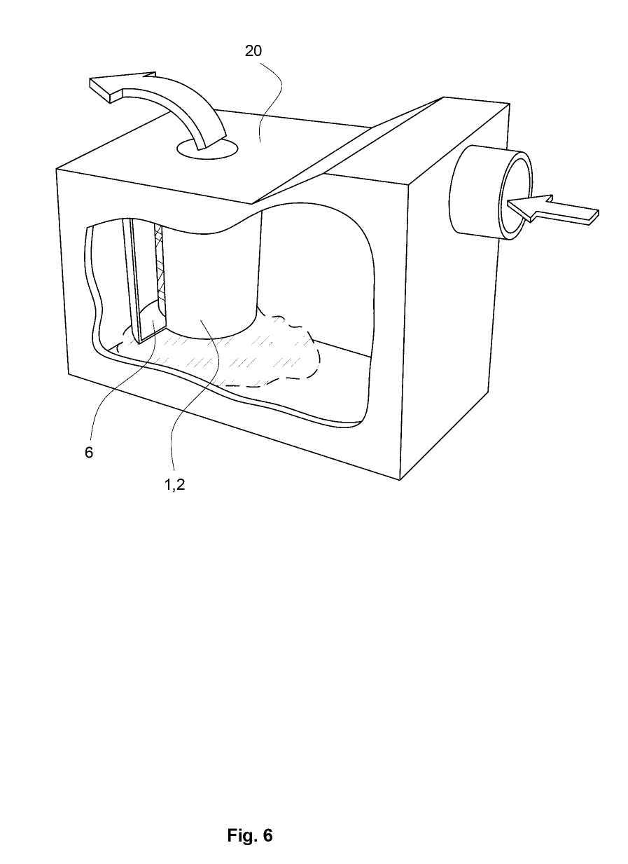

FIG. 6 shows a discharge application where separation device 1, similar in structure to that of the first embodiment has been installed in a chamber 20, whereby a FSS passes into chamber 20 and then processed through separation device 1.

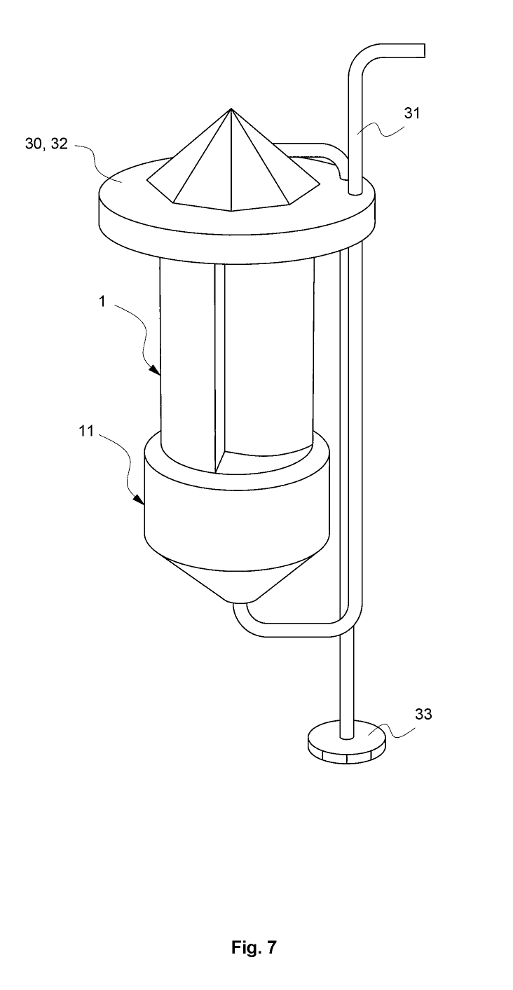

FIG. 7 shows an application where separation device 1 along with its associated sump 11 is integrated into a bio-buoy 30 and movable along a restraint pole 31. This buoy 30 can be applied to water (or other FSS) bodies for the removal of undesired materials. In this embodiment the flow of FSS into device 1, can be affected by an internal pump 32, which can be either externally powered or self propelled, drawing water (or other FSS) into separation device 1. A further benefit would be to pump the water (or other FSS) though an aeration nozzle creating air bubbles that are forced downwardly and discharged at a suitable depth.

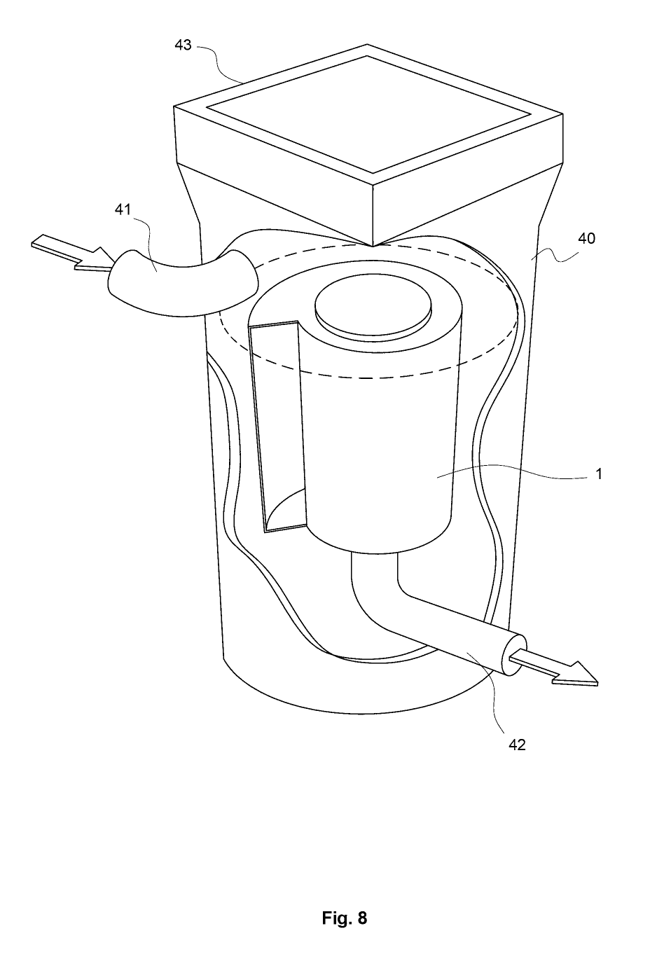

FIG. 8 depicts another example depicted in which separation device 1 can be housed in a chamber 40 having an chamber inlet 41, chamber outlet 42 and a service access lid 43. Such an arrangement could be used for treating environmental water flows. The lower region 45 of chamber 41 could have sediment and larger/heavier particulate matter settle therein, and buoyant materials would congregate in the upper region of chamber 41. Contaminated water flowing into separator device 1 could be used to remove finer particulate materials, and then module 10 (and possibly other nested modules) could be filtration media suited to removal of oil/grease.

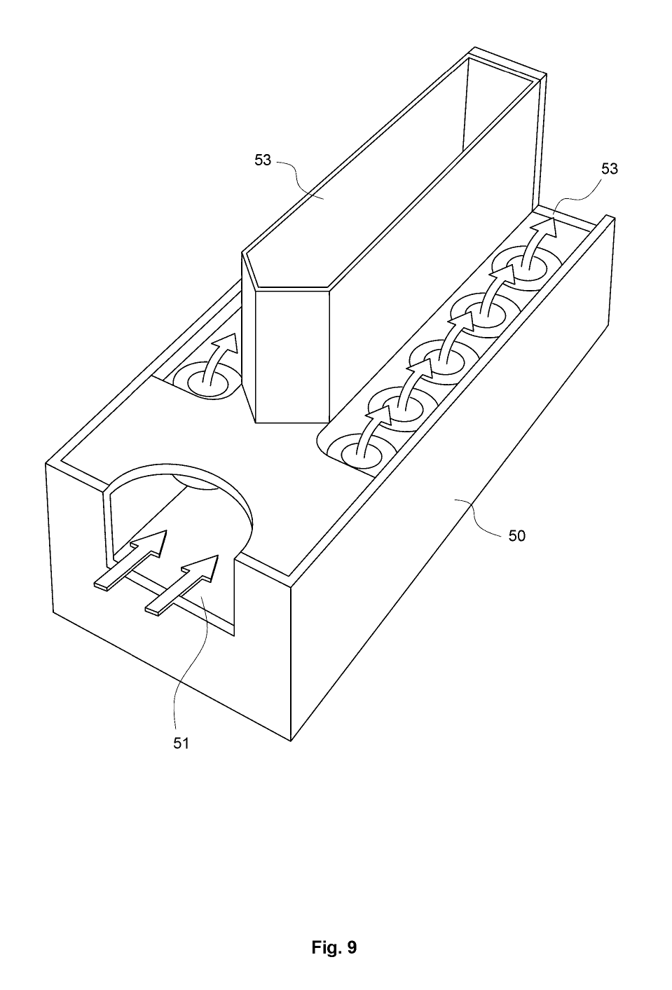

FIG. 9 depicts another example for use in environmental water flows, such as stormwater treatment, where a plurality of separation devices 1 can be housed in a large chamber 50 having an chamber inlet 51, chamber outlet 52 and an upper chamber section 53 providing service access and containment of buoyant materials. Upper chamber 53 could also house additional filtration devices.

In the abovementioned first embodiment shown in FIGS. 1 to 4, the substantially cylindrical surface of module 10 imparts a centrifugal force to the clay particles in the FSS forcing them outwardly and minimising their contact with module 10. If the module 10 (and optionally 10a) is operably rotated about central axis L of housing 2 during operation of device 1, then it increases the centrifugal forces imparted on the FSS, thereby making device 1 more efficient. This rotation of module 10, may be driven utilising an external power source (not shown), or by an impeller attached thereto able to be rotated by the flow of the FSS. Such rotation of module 10 will be dependent on the nature and components of the FSS. In order to improve screening efficiency, module 10 (having an external screen material) is rotated in the direction of the fluid flow.

In static designs the screening efficiency is improved by directing the fluid flow tangentially around module (having an external screen material) 10 and maintaining a constant velocity of the fluid on the outside of module via scrolled external housing 2, with a reducing radius rᵥ in accordance with an Archimedean spiral. However, rotation of module 10 will improve screening efficiency by causing module 10 to rotate at a tangential velocity greater than the FSS tangential velocity, hence imparting a reverse shear interface R_{IS}. This interface improves screening efficiency by:—
1. Causing the apparent aperture available for a particle to be reduced;
2. The rotational velocity being greater than the FSS and hence the heavier/larger particles deflect back into the fluid flow allowing settlement to occur;
3. The reverse shear interface also imparts a self cleaning action at the module (screen) 10 to fluid interface. This is particularly important for causing particles that have an adhesion attribute to be mobilised and released from the surface of module 10.

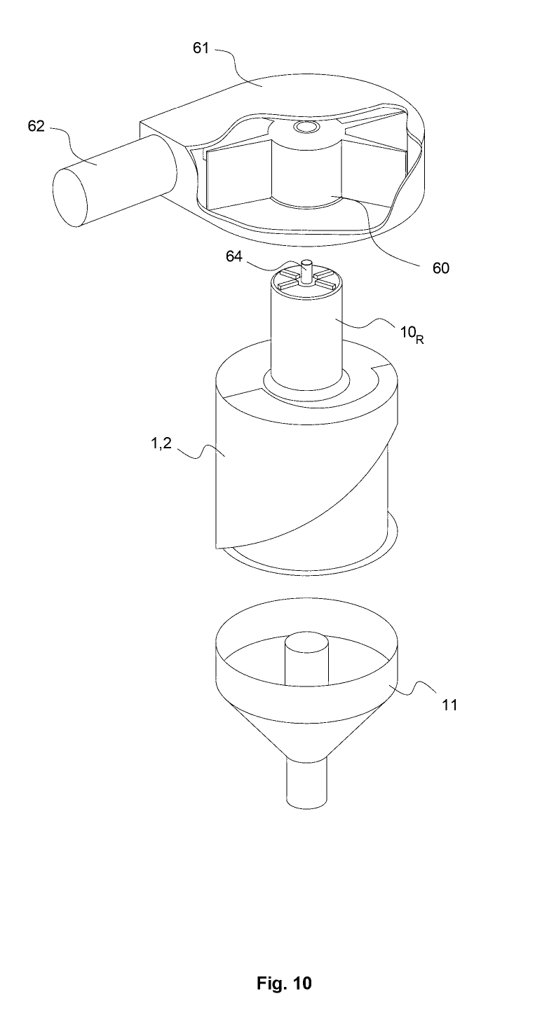

Rotation of module (with external screen material) 10 can be achieved by using a passive method, as shown in FIG. 10, where an impeller 60 is driven by the FSS entry energy. Impeller 60 could be radial as shown, or axial (not shown) such as a turbine, fitted to either the entry fluid, or the exit fluid in a pressurised application. In this embodiment radial impeller 60 is disposed within impeller housing 61 having an entry port 62, then an exit port (hidden), whereby FSS (fluid) causes impeller to rotate with a fluid flow. Impeller 61 engages with drive members 64 on module 10_{R}. The size of the entry port 61 is substantially smaller than the inlet 6 in housing 2, as a higher fluid velocity is maintained in entry port 62 to impose a higher rotational velocity to module 10_{R}, than the flow entering housing 2.

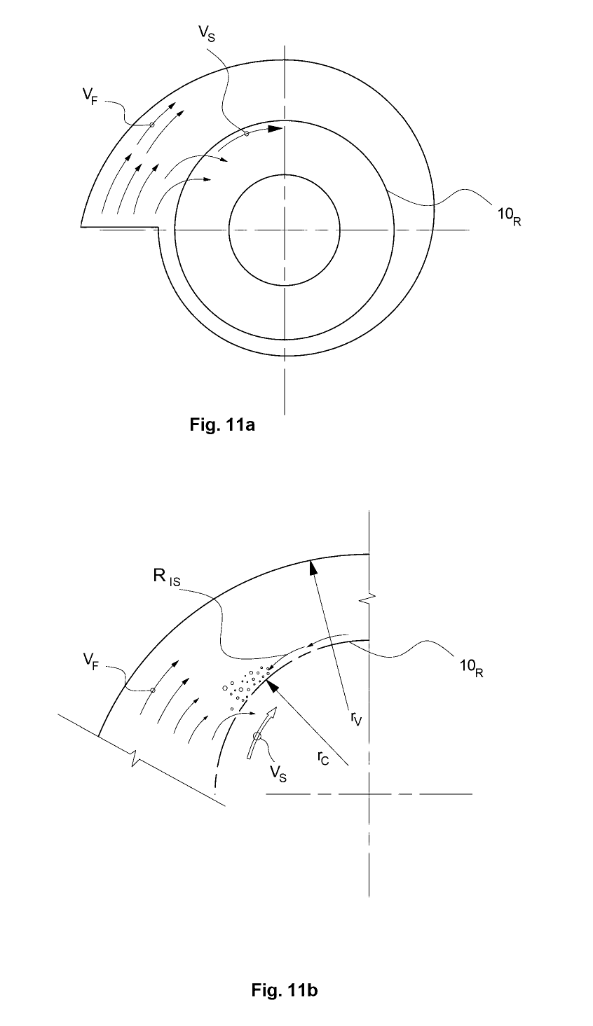

FIGS. 11a and 11b show rotating module (with external screen material) 10_{R}. Module 10_{R} has a constant radius r_{c}, whilst the ever decreasing radius rᵥ of the wall 3 is variable when viewed in cross section. V_{F} is the fluid velocity which is variable across the inlet (opening) 6. V_{S} is the velocity of the rotating module, and V_{S} is greater than V_{F}. The ratio by which V_{S}>V_{F} will vary subject to fluid viscosity. The reverse shear interface is indicated by arrows R_{Is}.

In another not shown embodiment module 10 can also be driven in applications where continuous operation is required. In a driven mode, the “module” drive could also be pulsed to improve performance and impart a cleaning action, replacing the back flushing action conventionally used.

The use of multi-stage separation device 1 is not limited to the applications described in the abovementioned embodiments. By using different media in module 10, it can for example be used for a variety of separation treatments in addition to or replacing filtration. The types of media used for separation purposes within the module 10,10a may vary depending on the application, and the FSS being treated may be affected by physical and/or chemical treatment within the elements.

The media used in module 10,10a may be of any known filtration/separation media and may include but is not limited to zeolite, activated carbon, spongolite and zirconium oxide. Furthermore, the media used in modules 10,10a may also include oxidants, reductants or metals (for the removal of bacteria). Furthermore, module 10,10a may be configured to act as a “biofilter” by containing microbes such as Bacillus spp.

It should also be understood that the media to be included in the modules 10,10a may also be a catalyst (catalytic material) that assist in the separation of FSS. For example, zeolite is not only used as an adsorbent but is also used as a catalyst in certain applications.

It should also be understood that modules 10,10a may include a hydrophobic or hydrophilic material as a lining, coating perforated mesh or the like on the inner or outer cylindrical surface of such module. Such hydrophobic or hydrophilic material may affect what goes into or comes out of module 10,10a as well as influencing the particle size separation that occurs within device 1.

The FSS to be treated may take many different forms and include:
Solids in liquids: insoluble solids particulates which can be treated by filtration or size exclusion. This also could be applied to microbial spores or cells, where the use of sonication or rapid pressure drop adds static functionality. Alternatively or in addition, the controlled addition of microbial cells and especially microbial spores will allow microbial processing of materials in media cores.
Sols: colloidal solids which can be flocced out or electrostatically coagulated, and filtered to a greater or lesser extent.
Soluble solids: used with cation or anion exchange media, chemical transformation by oxidation (gas, liquid or solid) or reduction or physically by electrostatic or electrical treatment.
Solids in gases: insoluble solids. Particulates including microparticles which can be treated by filtration, size exclusion etc, but can also be treated by sonics, or with liquids to physically scrub out these particles.
Liquid in liquid: mixtures of liquids which are fully miscible, enhancing or enriching one component based on molecular size, density or other property or specific ligand binding ie differential affinity or different hydrophobicity, based on different media. In simple terms this is called “partitioning” rather than filtration.
Emulsions: two liquids held within one phase by a third chemical entity, an emulsifier, the removal of which, based on molecular size or hydrophobicity, will destabilise the emulsion & allow separation of the components, most likely by means of differential density.
Liquids in gases: residual liquid as vapour in gas eg moisture in LNG, LPG, CSG so really liquid in compressed liquid in this case.
Aerosols: micro droplets in a stream of gas which can be removed by adsorption onto a medium as is, or increased in density by interaction with another introduced colloid to destabilise same before removal by adsorption. This is a type of enhanced filtration.
Gas in gas: mixtures of gases, using the separation device 1 to enrich or enhance one component at the expense of the other. (See also liquid in liquid above).
Gaseous poisons in gas stream (eg ammonia or hydrogen sulfide) which can be chemically transformed by oxidation (treated) in these cases, or reduction in the case of sulfur dioxide or nitrogen dioxide. There are other examples here of toxic vapours which could be neutralised by the device.
Gas in liquid: bubbles, froths & foams In general these can be removed based on density alone or by DAF units, or reduced by added chemicals eg amyl alcohol.
Gas dissolved in liquid eg oxygen dissolved in water could be affected using the media core to increase surface area under reduced pressure.

In the first embodiment, device 1 is “non-pressurised” and gravity is relied upon for flow of FSS there through. However, it should be understood that where multi-stage separation device 1 is being used for gases and volatiles, it will need to be pressurised. For example a pump upstream of device 1 may be necessary to pressurise the FSS passing through device 1. Pressurisation is not limited to gases and volatiles, and liquids may also be pressurised by a pump upstream of device 1.

The multi-stage separation device of the present invention, utilising a module containing zeolite and/or an oxidant, could be used to remove malodorous gases such as hydrogen sulphide (H₂S) or ammonia (NH₃). This has applications in sewage treatment risers, as well as in poultry sheds and other intensive animal feed lots. In the latter, malodourous volatile gases can be reduced by exhausting air within the sheds and feed lots through the multi-stage separation device of the present invention, which is being kept moist by water sprayers or drippers.

At present there are a number of problems associated with “plastics” or “hair” contained in a FSS that can be addressed. One such problem relates to synthetic fibres from clothes released in washing machines, and another is the breakdown of plastic items, including microplastics from cosmetics and industrial processes that enter treatment plants and stormwater treatment. Another problem is the unwanted hair from humans and animals, in commercial processes including the de-hairing of animal hides. The multi-stage separation device of the present invention can be used with modules adapted to capture synthetic fibres, hair and fragments of plastic.

It should be understood that multi-stage separation device 1 of the present invention, can be employed in different configurations and orientations. For example the removal of water from a gas stream can be handled with a module 10 containing hydrophilic adsorbent material in a substantially horizontal flow configuration. Another example is the removal of vapours from a low molecular mass from a forced air exhaust system that can be achieved in a vertical configuration (bottom to top system), such as in removing styrene vapour in the manufacture of polystyrene.

It is known in the prior art to utilise zeolite and water for heating and cooling purposes. The multi-stage separation device of the present invention employing zeolite as the module material may be employed to heat and cool air efficiently as an improvement on the control of temperature in buildings.

It is known in the prior art to use silver/silver alloy to disinfect water (kill bacteria therein) by electrolysis which employs a silver/silver alloy electrode which is immersed in the water connected to a direct current source for the production of silver ions. In the embodiment where the rotating module 10_{R} occurs impeller or other drive means, it is possible to provide a direct current source that could be delivered to electrodes disposed within module 10_{R} for the purpose of killing bacteria in a fluid passing through multi-stage separation device of the present invention.

The terms “comprising” and “including” (and their grammatical variations) as used herein are used in an inclusive sense and not in the exclusive sense of “consisting only of”.

1. A multi-stage separation device for separating a first fluid from at least one other second substance, said first fluid and said second substance forming a flowable system of substances, said device comprising:
a housing having a substantially cylindrical form about a central axis with a wall disposed between a first end and second end, an inlet disposed between said first end and said second end and an outlet in said second end, wherein said wall when viewed in cross section perpendicular to said central axis having an ever decreasing radius spiraling between at least a first edge of said wall and a second edge of said wall, said first edge and second edge form part of the periphery of said inlet in said housing, and at least one permeable cylindrical separation module disposed within said housing.

2. A multi-stage separation device as claimed in claim 1, wherein said inlet allowing said flowable system of substances to enter said housing such that flow thereof passes through said separation module as it flows towards said outlet, and at least a portion of said second substance is separated from said first fluid as it passes through said module.

3. A multi-stage separation device as claimed in claim 2, wherein said flowable system of substances entering said inlet at least initially has a spirally inward path imparted thereto.

4. A multi-stage separation device as claimed in claim 1, wherein said at least one module provides multi-modal separation.

5. A multi-stage separation device as claimed in claim 1, wherein said at least one module is a plurality of modules nested together.

6. A multi-stage separation device as claimed in claim 1, wherein at least two of said plurality of modules provide dissimilar modes of separation to each other.

7. A multi-stage separation device as claimed in claim 1, wherein said at least one module is made up of at least two segments, each segment providing a mode of separation dissimilar to each other.

8. A multi-stage separation device as claimed in claim 1, wherein said device is housed in a chamber.

9. A multi-stage separation device as claimed in claim 8, wherein said chamber houses a plurality of like said multi-stage separation devices.

10. A multi-stage separation device as claimed in claim 1, wherein said device can be used with anyone or more flowable system of substances, including, solids in liquid, sols, soluble solids, solids in gases, liquids in liquids and liquids in gases.

11. A multi-stage separation device as claimed in claim 1, wherein said module is disposable.

12. A multi-stage separation device as claimed in claim 1, wherein said module is rotatable about said central axis.

13. A multi-stage separation device as claimed in claim 12, wherein the rotation of said module is driven by the flow of the flowable system passing through said device.

14. A multi-stage separation device as claimed in claim 12, wherein the rotation of said module is driven by an external drive source.

15. A multi-stage separation device as claimed in claim 1, wherein said flowable system of substances entering said device is pressurised.

16. A multi-stage separation device as claimed in claim 1, wherein said flowable system of substances is pressurised by a pump disposed upstream of said device.

17. A multi-stage separation device as claimed in claim 1, wherein said separation module includes any one or more of separation media, filtration media, catalytic material, hydrophobic material, hydrophilic material, oxidant material, reductant material, metal or microbes.

18. A multi-stage separation device as claimed in claim 1, wherein said separation module comprises a material that transforms said second substance.

19. A multi-stage separation device as claimed in claim 1, wherein said separation device is integral with a buoy.

20. A multi-stage separation device as claimed in claim 1, wherein said separation device is used in aquaculture to treat contaminated water.

21. A multi-stage separation device as claimed in claim 1, wherein said separation device is used to treat environmental water flow.

22. A multi-stage separation device as claimed in claim 1, wherein said separation device is used to treat malodourous and/or volatile gases.
